(19) United States
(12) Patent Application Publication
(10) Pub. No.: US 2022/0163750 A1
(43) Pub. Date: May 26, 2022

(54) LENS STRUCTURE AND METHOD FOR ASSEMBLING SAME, AND CAMERA MODULE

(71) Applicant: JIANGXI JINGCHAO OPTICAL CO., LTD., Nanchang (CN)

(72) Inventors: Dezhong HU, Nanchang (CN); Junfu WU, Nanchang (CN); Hairong ZOU, Nanchang (CN)

(73) Assignee: JIANGXI JINGCHAO OPTICAL CO., LTD., Nanchang (CN)

(21) Appl. No.: 17/440,786

(22) PCT Filed: Jan. 15, 2020
(86) PCT No.: PCT/CN2020/072135

§ 371 Date: Sep. 19, 2021

(30) Foreign Application Priority Data
Mar. 27, 2019 (CN) 201910236750.1
Mar. 27, 2019 (CN) 201920399036.X

(51) Int. Cl. G02B 7/02; G02B 5/00

(52) U.S. Cl. CPC G02B 7/021; G02B 5/003

(57) ABSTRACT

A lens structure, comprising: a lens barrel having a hollow structure, comprising an object side end face and an image side end face; a lens group, comprising multiple lenses arranged in the lens barrel, the multiple lenses being sequentially arranged from the image side end face to the object side end face, the lens located on an end of the lens group and close to the object side end face being a first lens, the first lens comprising a first optical portion and a first mounting portion connected together, the first mounting portion being on the first optical portion; a light shielding sheet, separated from the lens barrel, arranged on the object side end face, and extending to an object side face of the first mounting portion, an object side face of the first optical portion being exposed from an object side face of the light shielding sheet.

### CROSS REFERENCE TO RELATED APPLICATIONS

This application is a national stage application, filed under 35 U.S.C. § 371, of International Patent Application No. PCT/CN2020/072135, filed Jan. 15, 2020, which claims priority of Chinese Patent Application No. 2019102367501, filed on Mar. 27, 2019, and Chinese Patent Application No. 201920399036X, filed on Mar. 27, 2019, the contents of each of which are incorporated herein by reference in their entireties.

### TECHNICAL FIELD

The present disclosure relates to the field of camera technology, in particular to a photosensitive component, a camera module, and a mobile terminal.

### BACKGROUND

As mobile terminals such as mobile phones and tablets evolve towards full screens, side frames of screens of mobile terminals have disappeared, and the upper and lower frames will become smaller and smaller or even disappear. This puts forward higher requirements for the miniaturization of camera modules configured on mobile terminals. The lens structure of a conventional camera module generally includes a lens barrel and lenses provided in the lens barrel. The front end of the lens barrel is configured to shield incident lights out of design, and prevent lights out of design from entering the lens structure. On the premise of not changing the optical performance (on the premises of the size, number and the like of lenses being the same), the size of the lens structure of the abovementioned structure is difficult to be further reduced, which cannot meet the ever-increasing demand for high screen-to-body ratio of mobile terminals.

### SUMMARY

According to various embodiments of the present disclosure, a photosensitive component that is capable of shielding the flow of the material forming the closure member to the photosensitive part of the photosensitive chip is provided.

A lens structure includes:

a lens barrel being a hollow structure having openings at both ends, the lens barrel comprising an object side end surface and an image side end surface;

a lens group comprising a plurality of lenses provided in the lens barrel, wherein the plurality of lenses are successively arranged from the image side end surface to the object side end surface, one of the lenses located at an end of the lens group and adjacent to the object side end surface is a first lens, the first lens includes a first optical portion and a first mounting portion that are connected to each other, and the first mounting portion is located on an outer periphery of the first optical portion; and

a light shielding plate separated from the lens barrel, the light shielding plate being provided on the object side end surface and extending to an object side surface of the first mounting portion, wherein an object side surface of the first optical portion is exposed from an object side surface of the light shielding plate.

A method for assembling a lens structure includes the following steps:

providing a lens barrel, the lens barrel being a hollow structure having openings at both ends, the lens barrel comprising an object side end surface and an image side end surface;

providing a plurality of lenses in the lens barrel, and the plurality of lenses are successively arranged from the image side end surface to the object side end surface, one of the lenses located at an end and adjacent to the object side end surface is a first lens, and the first lens includes a first optical portion and a first mounting portion that are connected to each other, the first mounting portion is located on an outer periphery of the first optical portion; and

providing a light shielding plate on the object side end surface, the light shielding plate extending to the object side surface of the first mounting portion, wherein the object side surface of the first optical portion is exposed from the object side surface of the light shielding plate.

A camera module includes the aforementioned lens structure.

The details of one or more embodiments of the present disclosure are set forth in the following drawings and description. Other features, objects and advantages of the present disclosure will become apparent from the description, drawings and claims.

### BRIEF DESCRIPTION OF THE DRAWINGS

In order to better describe and illustrate the embodiments and/or examples of those inventions disclosed herein, one or more drawings may be referred to. The additional details or examples used to describe the drawings should not be considered as limitation on the scope of any of the disclosed inventions, the currently described embodiments and/or examples, and the best mode of these inventions currently understood.

FIG. 1 is a cross-sectional view of a lens structure provided by an embodiment of the present disclosure;

FIG. 2 is a cross-sectional view of a lens structure provided by another embodiment of the present disclosure;

FIG. 3 is a partially exploded view of the lens structure shown in FIG. 2;

FIG. 4 is a cross-sectional view of a lens structure provided by another embodiment of the present disclosure;

FIG. 5 is a cross-sectional view of a lens structure provided by another embodiment of the present disclosure;

FIG. 6 is a cross-sectional view of a lens structure provided by another embodiment of the present disclosure;

FIG. 7 is a perspective view of a lens structure provided by another embodiment of the present disclosure;

FIG. 8 is an assembled state view of the lens structure shown in FIG. 7 in a first state;

FIG. 9 is an assembled state view of the lens structure shown in FIG. 7 in a second state;

FIG. 10 is a cross-sectional view of a lens structure provided by a conventional embodiment;

FIG. 11 is a cross-sectional view of a lens structure provided by another conventional embodiment;

FIG. 12 is a flowchart of a method for assembling a lens structure provided by an embodiment of the present disclosure;

FIG. 13 is a flowchart of step S720 in FIG. 12;

FIG. 14 is an assembled state view of the lens structure in the first embodiment 1 in a first state;

FIG. 15 is an assembled state view of the lens structure in the first embodiment in a second state;

FIG. 16 is an assembled state view of the lens structure in the first embodiment in a third state;

FIG. 17 is a cross-sectional view of the assembled lens structure in the first embodiment;

FIG. 18 is an assembled state view of the lens structure in the second embodiment in a first state;

FIG. 19 is an assembled state view of the lens structure in the second embodiment in a second state;

FIG. 20 is an assembled state view of the lens structure in the second embodiment in a third state;

FIG. 21 is a cross-sectional view of the assembled lens structure in the second embodiment;

FIG. 22 is an assembled state view of the lens structure in the third embodiment in a first state;

FIG. 23 is an assembled state view of the lens structure in the third embodiment in a second state;

FIG. 24 is an assembled state view of the lens structure in the third embodiment in a third state;

FIG. 25 is a cross-sectional view of the assembled lens structure in the third embodiment;

FIG. 26 is a cross-sectional view of a camera module provided by an embodiment of the present disclosure.

### DETAILED DESCRIPTION OF THE EMBODIMENTS

In order to make the aforementioned objects, features and advantages of the present disclosure more obvious and understandable, the specific embodiments of the present disclosure will be described in detail below with reference to the accompanying drawings. In the following description, many specific details are set forth so as to fully understand the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

It should be noted that, when an element is referred to as being “fixed to” another element, it can be directly on another element or an intermediate element may also exist. When an element is considered to be “connected to” another element, it can be directly connected to another element or an intermediate element may exist at the same time.

Unless otherwise defined, all technical and scientific terms used herein have the same meaning as commonly understood by those skilled in the technical field of the present disclosure. The terms used in the specification of the present disclosure herein are only for the purpose of describing specific embodiments, and are not intended to limit the present disclosure. The term “and/or” as used herein includes any and all combinations of one or more related listed items.

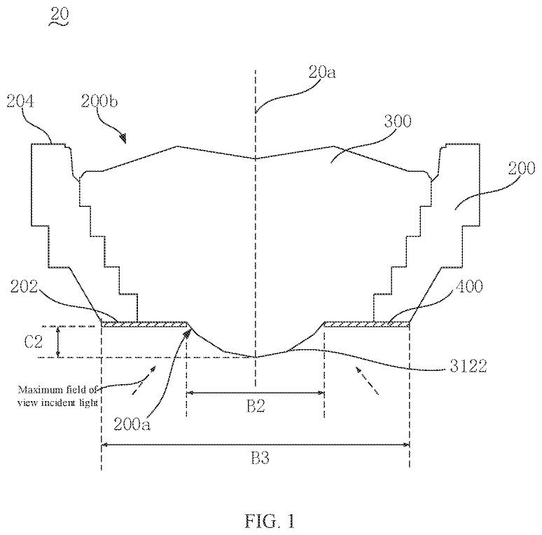

As shown in FIG. 1, a lens structure 20 according to an embodiment of the present disclosure includes a lens barrel 200, a lens group 300, and a light shielding plate 400.

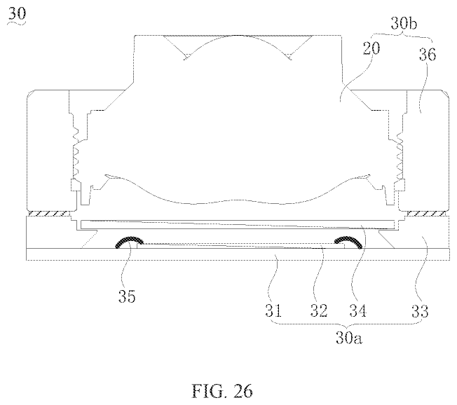

The lens barrel 200 is of a hollow structure having openings respectively at both ends. The lens barrel 200 includes an object side end surface 202 and an image side end surface 204 at opposite sides thereof. An opening of the lens barrel 200 on the object side end surface 202 is a first light passing opening 200a, and an opening of the lens barrel 200 on the image side end surface 204 is a second light passing opening 200b. Light can enter the lens barrel 200 through the first light passing opening 200a. After the light entering the lens barrel 200 passes through the lens group 300, it is incident on a photosensitive chip 32 (referring to FIG. 26) through the second light passing opening 200b, thereby realizing imaging.

As shown in FIG. 2, the lens group 300 includes a plurality of (two or more) lenses 300a, and the plurality of lenses 300a are successively arranged from the object side end surface 202 to the image side end surface 204. Each lens 300a includes an optical portion and a mounting portion that are connected to each other. The mounting portion is located on an outer periphery of the optical portion, typically surrounds the optical portion. In other words, the mounting portion is of a closed ring-shaped structure, which facilitates the assembly of the lenses 300a in the lens barrel 200. A lens 300a located at an end of the lens group 300 and adjacent to the object side end surface 202 is a first lens 310. The first lens 310 includes a first optical portion 312 and a first mounting portion 314 that are connected to each other. The first mounting portion 314 is located on the outer periphery of the first optical portion 312.

The light shielding plate 400 is separated from the lens barrel 200, that is, the light shielding plate 400 and the lens barrel 200 are formed separately. The light shielding plate 400 is provided on the object side end surface 202 and extends to an object side surface 3142 of the first mounting portion 314. The object side surface 3122 of the first optical portion 312 is exposed from the object side surface 402 of the light shielding plate 400.

As shown in FIG. 10, in the conventional lens structure 10, the integrally formed lens barrel 12 has a front end plate (object side end plate) 122 having a light passing opening 1222. The lens barrel 12 is generally formed by injection molding of black plastic, such that the front end plate 122 is opaque and can shield light, thus preventing light out of design from entering the lens structure 10 (the light entering the lens structure 10 through the light passing opening 1222 being the light within the design). Due to the process limitation of the integrally forming of the lens barrel 12 and the structural limitation of the lenses 142 in the lens group 14, a thickness A (size in the direction of the optical axis 10a) of the front end plate 122 is difficult to be made small. The object side surface 1224 of the front end plate 122 is coplanar with the object side surface 1422 of the lenses 142, that is, the lenses 142 are completely received in the lens barrel 12.

As shown in FIGS. 10 and 11, on the basis of FIG. 10, the lens structure shown in FIG. 11 is obtained after various optimizations. A thickness of the front end plate 122 (a thickness between the inner wall and the outer wall of the light passing hole 1222) is reduced, and a head size (width of head portion) of the lens structure 10 is reduced from B in FIG. 10 to B1 in FIG. 11. If the thickness of the front end plate 122 is further reduced, the area at the dashed circle R shown in FIG. 11 will not be able to be formed due to thickness being too small. Therefore, the head width B1 of the conventional lens structure 10 generally cannot be further reduced. The head width of the lens structure 10 is unable to be further reduced, resulting in the lens structure 10 being unable to meet the gradually increasing demand for high screen-to-body ratio of mobile terminals.

As shown in FIGS. 1 and 2, in the aforementioned lens structure 20, the lens barrel 200 and the light shielding plate 400 are formed separately. The thickness of the light shielding plate 400 (the size along the optical axis 20a) is not limited by the integrally forming process of the lens barrel 200 and the structure of the lenses 300a. The light shielding plate 400 with a smaller thickness can be used to shield light, such that the object side surface 3122 of the first optical portion 312 can be exposed from the object side surface 402 of the light shielding plate 400, therefore the head width B2 of the aforementioned lens structure 20 can be determined by the width (the size on the horizontal plane) of the exposed lenses 300a. Compared with the head width B1 of the conventional lens structure 10, the thickness of the lens barrel 200 is at least subtracted from the head width B2 of the aforementioned lens structure 20. Therefore, compared with the conventional lens structure 10, the aforementioned lens structure 20 has a feature of smaller head width.

In some embodiments, the head width B2 of the aforementioned lens structure 20 is in a range from 1 mm to 3 mm. In other words, when the light shielding plate 400 is ring-shaped (at this time, a through hole is formed in a center portion of the light shielding plate 400), a diameter (inner diameter) of the through hole of the light shielding plate 400 is in a range from 1 mm to 3 mm. In some embodiments, an outer diameter B3 of the object side end surface 202 of the lens barrel 200 is in a range from 1.2 mm to 5 mm. In some embodiments, the thickness of the light shielding plate 400 is in a ranged from 0.01 mm to 0.2 mm.

As shown in FIGS. 10 and 11, in the conventional lens structure 10, the head depth C or C1 of the lens structure 10 is the distance between the head and the step surface closest to the object side at an outside the lens barrel 12. The head depth C or C1 of the conventional lens structure is greater than or equal to the thickness A of the front end plate 122.

In some embodiments, as shown in FIGS. 1 and 2, the light shielding plate 400 is laminated on the object side end surface 202 of the lens barrel 200. As such, the light shielding plate 400 can be provided on the object side end surface 202 without performing slotting on the object side end surface 202 of a planar structure. In some embodiments, an outer sidewall of the light shielding plate 400 is coplanar with the outer sidewall of the lens barrel 200 adjacent thereto. As such, the front end surface of the lens structure 20 can be formed as a flat surface. It should be understood that, in some other embodiments, the outer sidewall of the light shielding plate 400 may also mate with the object side end surface 202 to form a step structure.

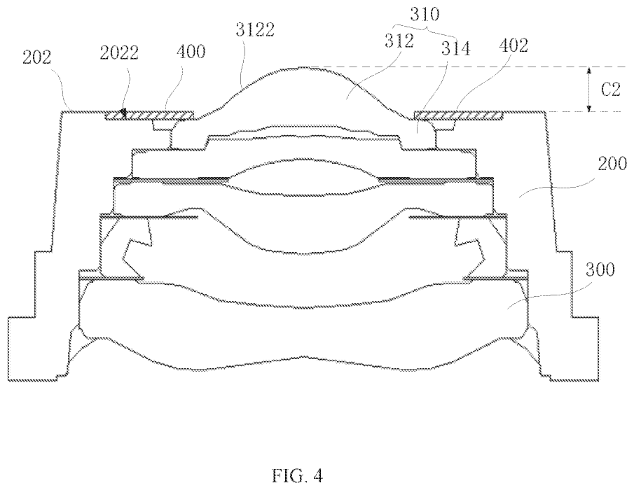

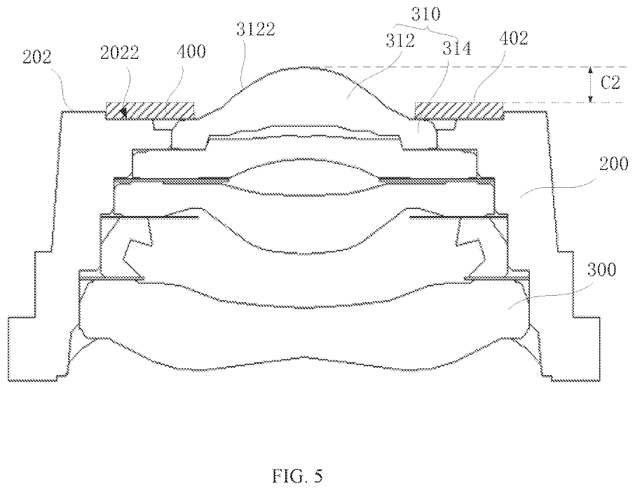

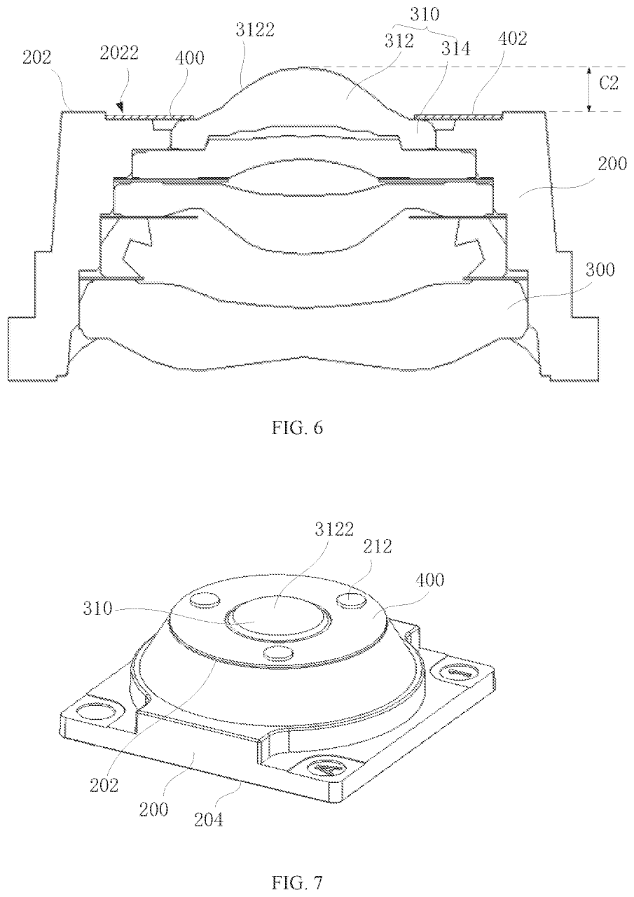

In some embodiments, as shown in FIG. 4, the object side end surface 202 of the lens barrel 200 is provided with a mounting groove 2022, and the light shielding plate 400 is disposed in the mounting groove 2022. As such, it is beneficial for the positioning and mounting of the light shielding plate 400. In some embodiments, the object side surface 402 of the light shielding plate 400 is coplanar with the object side end surface 202 of the lens barrel 200. As such, the front end surface of the lens structure 20 can be formed as a flat surface. In some embodiments, as shown in FIG. 5, the object side surface 402 of the light shielding plate 400 is located between the object side end surface 202 of the lens barrel 200 and the object side surface 3122 of the first optical portion 312. In some embodiments, as shown in FIG. 6, the object side surface 402 of the light shielding plate 400 is located between the object side end surface 202 and the image side end surface 204 of the lens barrel 200.

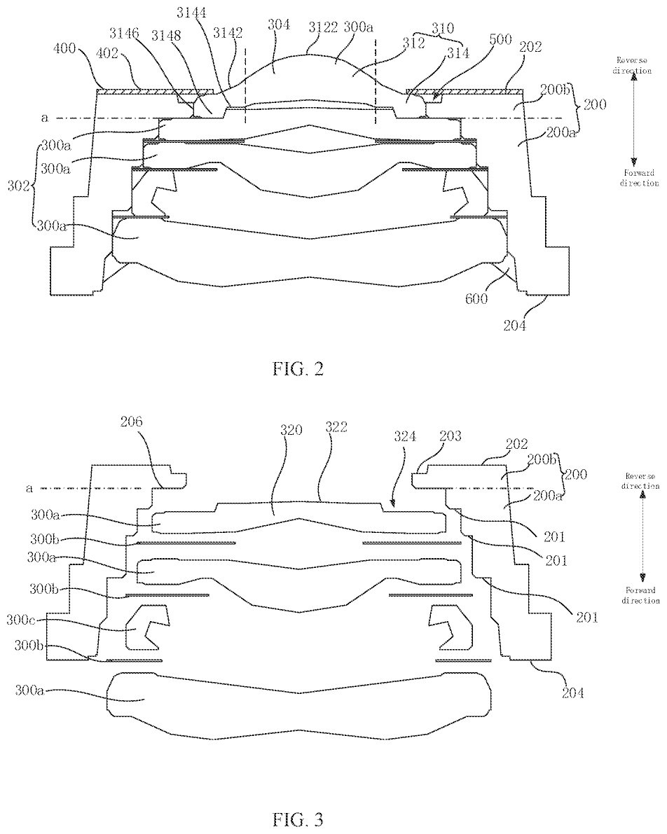

In the embodiments shown in FIGS. 1, 2, 4, and 5, a maximum distance between the object side surface 3122 of the first optical portion 312 and the object side surface 402 of the light shielding plate 400 is a head depth C2 of the aforementioned lens structure 20. In the embodiment shown in FIG. 6, a maximum distance between the object side surface 3122 of the first optical portion 312 and the object side end surface 202 of the lens barrel 200 is a head depth C2 of the aforementioned lens structure 20. That is, a maximum distance between the object side surface 3122 of the first optical portion 312 and a higher one between the object side surface 402 of the light shielding plate 400 and the object side end surface 202 of the lens barrel 200 is the head depth C2 of the aforementioned lens structure 20. In some embodiments, the head depth of the aforementioned lens structure 20 is in a range from 0.1 mm to 2 mm Therefore, compared with the conventional lens structure 10, the aforementioned lens structure 20 has a feature of smaller head depth. As shown in FIGS. 2 and 3, in some embodiments, the lens barrel 200 is provided with a reference step surface 206 therein configured to support the object side surface of the lenses 300a. A direction from the reference step surface 206 to the object side end surface 202 is a reverse direction, and a direction from the reference step surface 206 to the image side end surface 204 is a forward direction. A part of the lens barrel 200 between the reference step surface 206 and the image side end surface 204 is a first barrel body 200a, and a part of the lens barrel 200 between the reference step surface 206 and the object side end surface 202 is a second barrel body 200b. The lenses located in the first barrel body 200a constitute the first lens unit 302, and the lenses located in the second barrel body 200b constitute the second lens unit 304. A dashed line a in FIGS. 2 and 3 is a boundary line between the first barrel body 200a and the second barrel body 200b.

In some embodiments, the inner diameter of the first barrel body 200a gradually increases in the forward direction, and the inner diameter of the second barrel body 200b gradually increases in the reverse direction. As such, the lenses 300a in the first lens unit 302 can be assembled in the first barrel body 200a in an order from small to large in the forward direction, and the lenses 300a in the second lens unit 304 can be assembled in the second barrel body 200b in an order from small to large in the reverse direction. In some embodiments, when the first lens unit 302 has only one lens 300a, or when the sizes of the lenses 300a in the first lens unit 302 are all the same, the inner diameter of the first barrel body 200a can also remain unchanged in the forward direction. Likewise, the inner diameter of the second barrel body 200b can also remain unchanged in the reverse direction.

In some embodiments, the inner wall of the first barrel body 200a is stepped. At this time, the inner diameter of the first barrel body 200a gradually increases intermittently rather than continuously in the forward direction. The first barrel body 200a is provided with at least one first step surface 201 therein that is located between the reference step surface 206 and the image side end surface 204. As shown in FIG. 3, the number of the first step surface 201 is three.

In some embodiments, the inner wall of the second barrel body 200b is stepped. At this time, the inner diameter of the second barrel body 200b gradually increases intermittently rather than continuously in the reverse direction. The second barrel body 200b is provided with at least one second step surface 203 therein that is located between the reference step surface 206 and the object side end surface 202. As shown in FIG. 3, the number of the second step surface 203 is one.

In some embodiments, a gasket 300b is provided between two adjacent lenses 300a. In some embodiments, the lens structure 20 further includes at least one spacer 300c. Each spacer 300c is provided between two adjacent lenses 300a, and the gasket 300b is provided between the spacer 300c and the adjacent lens 300a.

In some embodiments, the lens structure 20 includes a spacer 300c, which is located between the two lenses 300a adjacent to the image side end surface 204. As such, when assembling a lens 300a that is located at an end of the lens group 300 and is adjacent to the image side end surface 204, i.e., when assembling the last lens 300a of the first lens unit 302, the spacer 300c can be used to support the last lens 300a and bear the pressure during assembling the last lens 300a.

In some embodiments, the first step surface 201 is configured to directly support the object side surface of the gasket 300b, and indirectly support the object side surface of the lenses 300a and the spacer 300c. In some embodiments, the second step surface 203 closest to the object side end surface 202 is idle, which is not configured to directly or indirectly support the lenses 300a, gasket 300b, and spacer 300c. The second step surface closest to the object side end surface 202 is spaced apart from the light shielding plate 400 to form a gap 500. Glue can be applied in the gap 500, so as to increase the firmness of the connection between the lenses 300a and the lens barrel 200.

In some embodiments, the first lens unit 302 includes one or more lenses 300a, and the second lens unit 304 includes one or more lenses 300a. In some embodiments, the sum of the number of lenses 300a of the first lens unit 302 and the number of lenses 300a of the second lens unit 304 is less than or equal to 7. As such, it is convenient to assemble and to obtain a small sized lens structure 20.

As shown in FIGS. 10 and 11, in the conventional lens structure 10, in addition to the effect of shading the light, the front end plate 122 also has the effect of positioning and fixing the lenses 142 in the lens barrel 12.

The following detail description illustrates how the lenses 300a of the aforementioned lens structure 20 is positioned and fixed in the lens barrel 12.

As shown in FIG. 2, in some embodiments, at least an image side surface 3144 of the first mounting portion 314 of the first lens 310 is located in the lens barrel 200. In some embodiments, an outer edge of the object side surface 3142 of the first mounting portion 314 of the first lens 310 is coplanar with the object side end surface 202 of the lens barrel 200.

As shown in FIGS. 2 and 3, in some embodiments, after all lenses 300a except the first lens 310 are assembled in the lens barrel 200, the first lens 310 is then placed in the lens barrel 200. The first lens 310 presses down the lens 320 adjacent to the first lens 310 under the action of gravity. The side surface 3146 of the first lens 310 abuts against the inner wall of the lens barrel 200. That is, the first lens 310 can be positioned by means of the adjacent lens 320, and positioned and fixed by means of abutting and fitting with the inner wall of the lens barrel 200.

In some embodiments, the image side surface 3144 of the first mounting portion 314 of the first lens 310 is provided with a positioning protrusion 3148, and the object side surface 322 of the lens 320 adjacent to the first lens 310 is provided with a positioning groove 324. When the first lens 310 is assembled in the lens barrel 200, the positioning protrusion 3148 is latched in the positioning groove 324, thereby increasing the positioning accuracy of the first lens 310.

In some embodiments, after all lenses 300a except the first lens 310 are assembled in the lens barrel 200, the first lens 310 is then placed in the lens barrel 200. The first lens 310 presses down the lens 320 adjacent to the first lens 310 under the action of gravity. Glue is applied on the object side surface 3142 of the first mounting portion 314 of the first lens 310 and the inner wall of the lens barrel 200 to fix the first lens 310. That is, the first lens 310 can be fixed by applying glue, and the object side surface 3142 of the first mounting portion 314 of the first lens 310 is connected to the inner wall of the lens barrel 200 by an adhesive layer.

In some embodiments, in addition to shielding lights, the light shielding plate 400 is further configured to fix the first lens 310 and the lens barrel 200. In some embodiments, the light shielding plate 400 abuts against the object side surface 3142 of the first mounting portion 314 of the first lens 310, so as to fix the first lens 310 and the lens barrel 200.

In some embodiments, the light shielding plate 400 is a glue layer. Specifically, light shielding glue may be coated on the object side end surface 202 of the lens barrel 200 and the object side surface 3142 of the first mounting portion 314, and the light shielding glue is cured to form the light shielding plate 400, such that the first lens 310 and the lens barrel 200 are firmly fixed. The light shielding glue may be black glue.

In some embodiments, the light shielding plate 400 is of a ring-shaped structure, and the light shielding plate 400 is sleeved on the first lens 310. The image side surface of the light shielding plate 400 includes a first annular connecting portion and a second annular connecting portion that are successively arranged and connected from outside to inside. The first annular connecting portion is fixedly connected to the object side end surface 202 of the lens barrel 200, and the second annular connecting portion abuts against the object side surface 3142 of the first mounting portion 314 of the first lens 310. That is, the inner edge of the image side surface of the light shielding plate 400 abuts against the object side surface 3142 of the first mounting portion 314 of the first lens 310, and the outer edge of the image side surface of the light shielding plate 400 is fixedly connected to the object side end surface 202 of the lens barrel 200.

In some embodiments, a glue layer is provided between the outer edge of the image side surface of the light shielding plate 400 and the object side end surface 202 of the lens barrel 200. In some embodiments, another glue layer is also provided between the inner edge of the image side surface of the light shielding plate 400 and the object side surface 3142 of the first mounting portion 314 of the first lens 310. That is, the light shielding plate 400 is respectively connected to the object side end surface 202 of the lens barrel 200 and the object side surface 3142 of the first mounting portion 314 by means of adhesive.

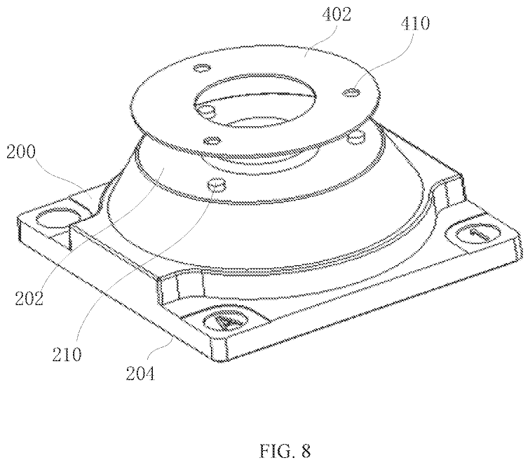

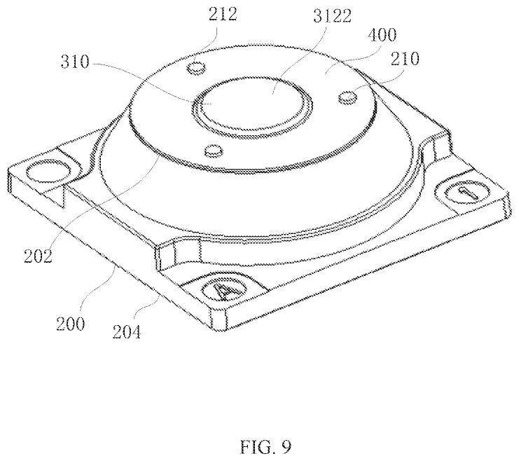

As shown in FIGS. 7, 8, and 9, in some embodiments, the object side end surface 202 of the lens barrel 200 is provided with a first positioning member 210, and the light shielding plate 400 is provided with a second positioning member 410 mating with the first positioning member 210. The first positioning member 210 and the second positioning member 410 are configured to improve the concentricity of the light shielding plate 400 and the lens barrel 200 when assembled. In some embodiments, the first positioning member 210 is a post, the second positioning member 410 is a through hole, and the post 210 extends through the through hole 410. In some embodiments, the first positioning member 210 and the second positioning member 410 are both through holes, and the assembly can be realized by using an external post.

In some embodiments, the first positioning member 210 is a post, the second positioning member 410 is a through hole, and the post 210 extends through the through hole 410. In some embodiments, the through hole 410 extends through the side surface 402 of the light shielding plate 400, such that it is convenient to adjust relative positions of the light shielding plate 400 and the lens barrel 200 in a direction from the inner edge to the outer edge of the light shielding plate 400, which is more beneficial for improving the concentricity of the light shielding plate 400 and the lens barrel 200 when assembled. In some embodiments, in a direction from the inner edge to the outer edge of the light shielding plate 400, the distance between the side walls of the through hole 410 gradually increases, which is very convenient for assembly.

In some embodiments, there are a plurality of posts 210 and a plurality of through holes 410 (more than or equal to two), and the posts 210 and the through holes 410 are in one-to-one correspondence. As such, it is more beneficial for improving the concentricity of the light shielding plate 400 and the lens barrel 200 when assembled. In some embodiments, there are three posts 210, and the three posts 210 are arranged at equal intervals.

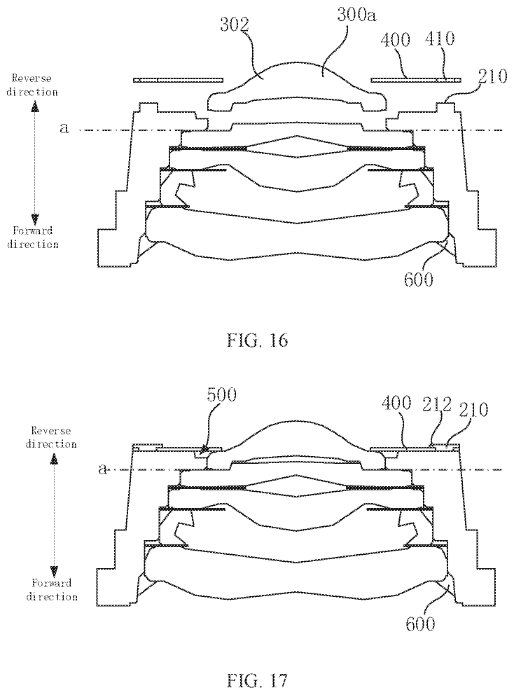

In some embodiments, the first positioning member 210 is a post, and the second positioning member 410 is a through hole. The post 210 extends through the through hole 410, and one end of the post 210 protrudes from the through hole 410. A part of the post 210 protruding from the through hole 410 is a hot riveting portion 212. The hot riveting portion 212 is hot riveted and fixed to the object side surface 402 of the light shielding plate 400, such that the inner edge of the image side surface of the light shielding plate 400 abuts against and is fixed to the object side surface 3142 of the first mounting portion 314 of the first lens 310. At this time, the light shielding plate 400 and the lens barrel 200 can be fixed without glue bonding, and the light shielding plate 400 abuts against the object side surface 3142 of the first mounting portion 314 of the first lens 310 at the same time, thereby incidents where glue contaminating the optical portion of the lenses 300a during the glue application process can prevented from happening. Specifically, as shown in FIGS. 16 and 17, after the hot riveting process, the height of the hot riveting portion 212 is reduced, and the outer diameter thereof is increased, thereby covering the through hole 410, thus achieving the fixation of the light shielding plate 400 and the lens barrel 200.

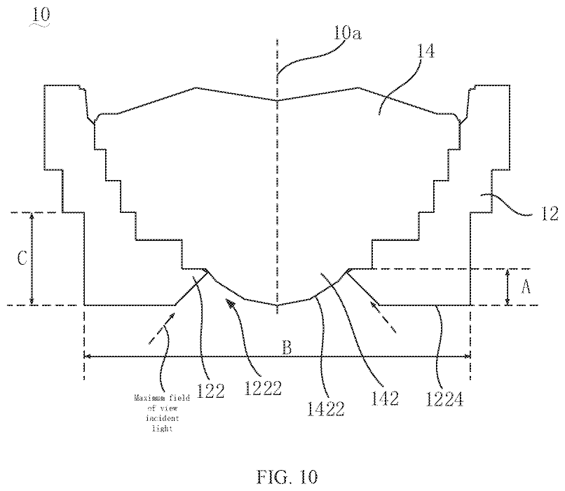

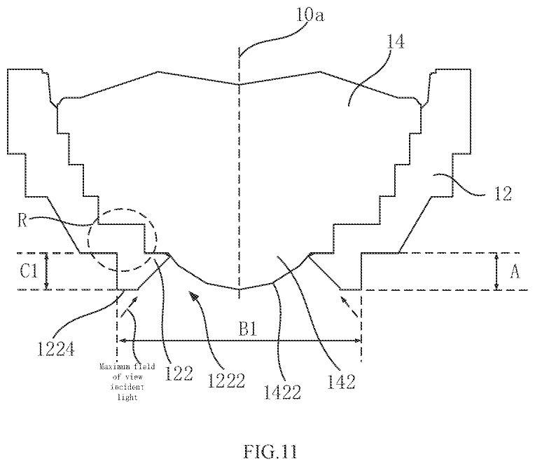

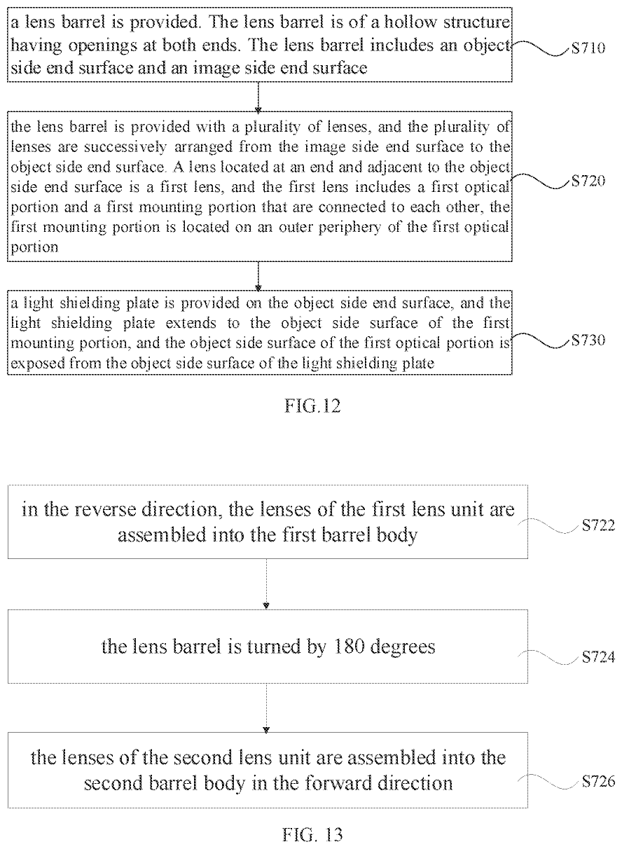

As shown in FIG. 12, a method for assembling a lens structure provided by an embodiment of the present disclosure includes the following steps:

In step S710, a lens barrel is provided. The lens barrel is of a hollow structure having openings at both ends. The lens barrel includes an object side end surface and an image side end surface.

In step S720, the lens barrel is provided with a plurality of lenses, and the plurality of lenses are successively arranged from the image side end surface to the object side end surface. A lens located at an end and adjacent to the object side end surface is a first lens, and the first lens includes a first optical portion and a first mounting portion that are connected to each other, the first mounting portion is located on an outer periphery of the first optical portion.

In step S730, a light shielding plate is provided on the object side end surface, and the light shielding plate extends to the object side surface of the first mounting portion, and the object side surface of the first optical portion is exposed from the object side surface of the light shielding plate.

As shown in FIG. 13, in some embodiments, step S720 includes the following steps:

In step S722, in the reverse direction, the lenses of the first lens unit are assembled into the first barrel body.

In step S722, after the lenses of the first lens unit are sequentially placed in the first barrel body, glue is applied on the mounting portion of the first lens unit adjacent to the image side end surface and the inner wall of the first barrel body, so that the lenses of the first lens unit are all fixed in the first barrel body.

In step S724, the lens barrel is turned by 180 degrees.

In step S726, the lenses of the second lens unit are assembled into the second barrel body in the forward direction.

In step S726, the lenses of the second lens unit are sequentially placed in the second barrel body. When the first lens is finally placed, the positioning protrusion of the first lens is latched in the positioning groove of the second lens, and the side surface of the first mounting portion of the first lens abuts against the inner wall of the lens barrel to realize the positioning and pre-fixation of the first lens.

In some embodiments, in step S730, one end of the post on the object side end surface protrudes from the through hole of the light shielding plate, a part of the post protruding from the through hole is a hot riveting portion, and the hot riveting portion is hot riveted and fixed on the object side surface of the light shielding plate, so that the light shielding plate abuts against and is fixed to the object side surface of the first mounting portion, such that the lenses of the second lens unit are fixed in the second barrel body.

The method for assembling the lens structure will be described in detail below with reference to three specific embodiments, where the lens structures in the three embodiments all include four lenses and a spacer.

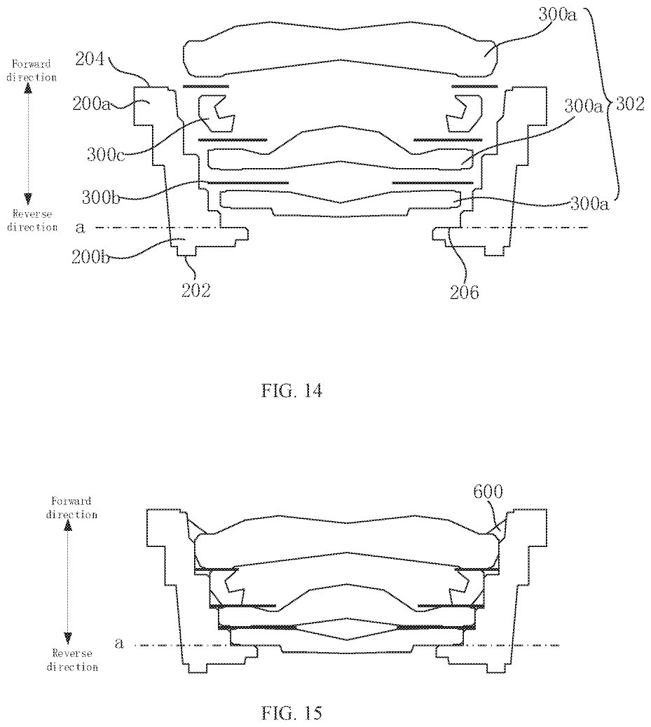

FIGS. 14 to 17 illustrate a first embodiment. In FIG. 14, in the reverse direction, the lenses 300a of the first lens unit 302, as well as the gaskets 300b and the spacer 300c are placed in the first barrel body 200a. The first lens unit 302 includes three lenses 300a, three gaskets 300b, and one spacer 300c. In FIG. 15, glue 600 is applied between the mounting portion of the uppermost lens 300b and the inner wall of the first barrel body 200a, so that the lenses 300a of the first lens unit 302, as well as the gaskets 300b and the spacer 300c are fixed in the first barrel body 200a. After turning the structure shown in FIG. 15 by 180 degrees, the structure shown in FIG. 16 is obtained. In FIG. 17, in the forward direction, the lens 300a of the second lens unit 304 is placed in the second barrel body 200b, and the light shielding plate 400 is fixed on the object side end surface of the lens barrel, so that the lens 300a of the second lens unit 304 is fixed on the second barrel body 200b, and the second lens unit 304 includes one lens 300a.

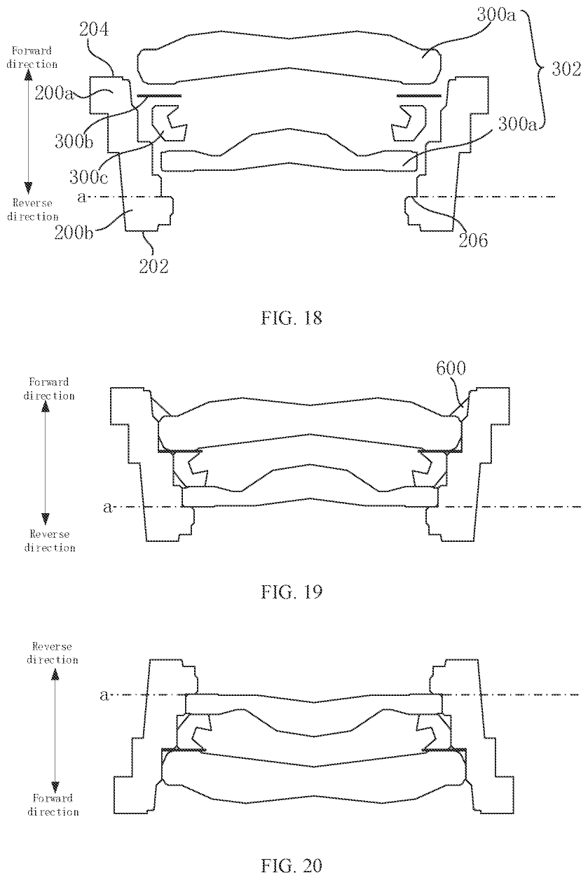

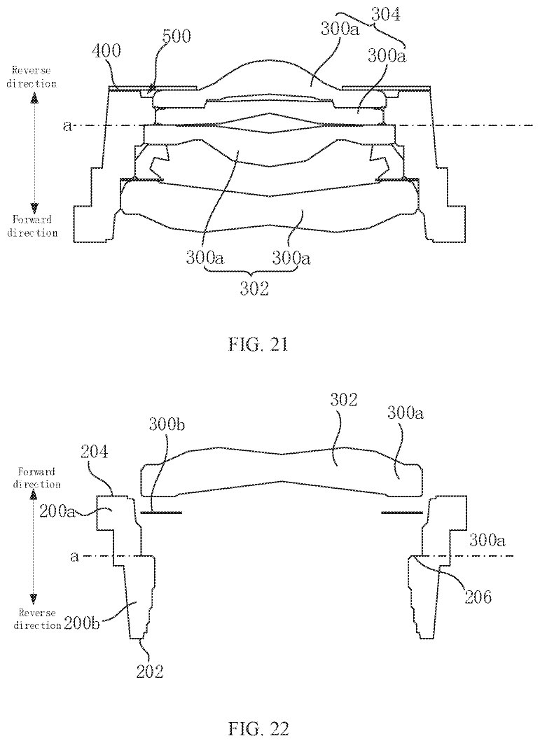

FIGS. 18 to 21 illustrate a second embodiment. In FIG. 18, in the reverse direction, the lenses 300a of the first lens 300a unit, as well as the gasket 300b and the spacer 300c are placed in the first barrel body 200a. The first lens 300a unit includes two lenses 300a, one gasket 300b, and one spacer 300c. In FIG. 19, glue is applied between the mounting portion of the uppermost lens 300a and the inner wall of the first barrel body 200a, so that the lenses 300a of the first lens 300a unit, as well as the gasket 300b and the spacer 300c are fixed in the first barrel body 200a. After turning the structure shown in FIG. 19 by 180 degrees, the structure shown in FIG. 20 is obtained. In FIG. 21, in the forward direction, the lenses 300a of the second lens 300a unit are placed in the second barrel body 200b, and the light shielding plate is fixed on the object side end surface of the lens barrel, so that the lenses 300a of the second lens 300a unit are fixed on the second barrel body 200b, and the second lens 300a unit includes two lenses 300a.

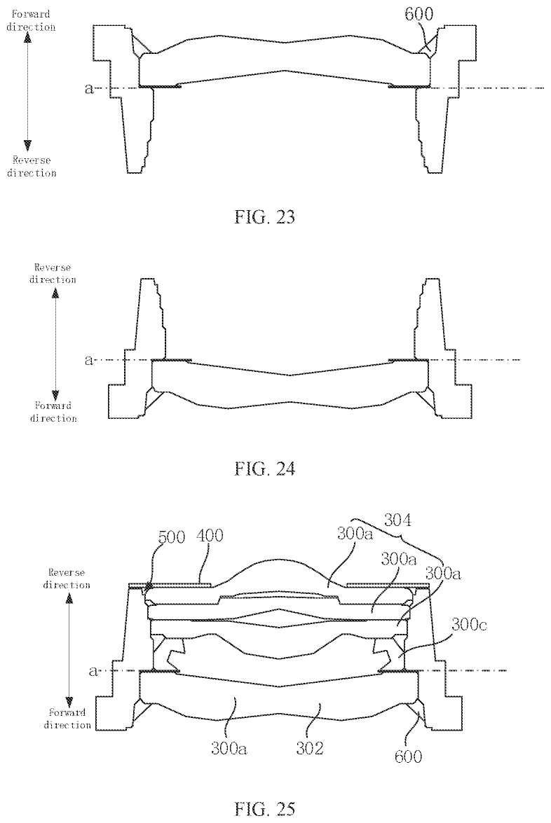

FIGS. 22 to 25 illustrate a third embodiment. In FIG. 22, in the reverse direction, the lens 300a of the first lens 300a unit and the gasket 300b are placed in the first barrel body 200a. The first lens 300a unit includes one lens 300a, and one gasket 300b. In FIG. 23, glue is applied between the mounting portion of the uppermost lens 300a and the inner wall of the first barrel body 200a, so that the lens 300a of the first lens 300a unit and the gasket 300b are fixed in the first barrel body 200a. After turning the structure shown in FIG. 20 by 180 degrees, the structure shown in FIG. 24 is obtained. In FIG. 25, in the forward direction, the lenses 300a of the second lens 300a unit and the spacer 300c are placed in the second barrel body 200b, and the light shielding plate is fixed on the object side end surface of the lens barrel, so that the lenses 300a of the second lens 300a unit, as well as the spacer 300c are fixed on the second barrel body 200b, and the second lens 300a unit includes three lenses 300a, and one spacer 300c.

As shown in FIG. 26, a camera module 30 is provided by an embodiment of the present disclosure, which can be applied to mobile terminals such as smart phones and tablet computers.

The camera module 30 generally includes a photosensitive component 30a and a lens component 30b. The photosensitive component 30a includes a circuit board 31, a photosensitive chip 32, a bracket 33, and an optical filter 34. The photosensitive chip 32 is provided on the circuit board 31. The bracket 33 is of a hollow structure having openings at both ends, which is provided on the circuit board 31. The photosensitive chip 32 is received in the bracket 33. The optical filter 34 is provided on a step portion of the bracket 33. The lens component 30b is provided on the end of the bracket 33 away from the circuit board 31.

The photosensitive chip 32 is electrically connected to the circuit board 31 through a gold wire 35. The lens component 30b includes a voice coil motor 36 and a lens structure 20 provided in the voice coil motor 36. The voice coil motor 36 can drive the lens structure 20 to move back and forth in directions of the optical axis to achieve focusing. At this time, the camera module 30 is an autofocus camera module. In some embodiments, when the camera module 30 is a fixed-focus camera module, a lens holder may be used to replace the voice coil motor 36. At this time, the lens structure 20 is fixedly connected to the lens holder. In some embodiments, the lens holder and the bracket 33 may be of an integrally formed structure, that is, the lens holder can be used to mount the lens structure 20, and can also be used to mount the optical filter 34 and contain the photosensitive chip 32.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A lens structure, comprising:
a lens barrel being a hollow structure having openings at both ends, the lens barrel comprising an object side end surface and an image side end surface;
a lens group comprising a plurality of lenses provided in the lens barrel, wherein the plurality of lenses are successively arranged from the image side end surface to the object side end surface, one of the lenses located at an end of the lens group and adjacent to the object side end surface is a first lens, the first lens comprises a first optical portion and a first mounting portion that are connected to each other, and the first mounting portion is located on an outer periphery of the first optical portion; and
a light shielding plate separated from the lens barrel, the light shielding plate being provided on the object side end surface and extending to an object side surface of the first mounting portion, wherein an object side surface of the first optical portion is exposed from an object side surface of the light shielding plate.

2. The lens structure of claim 1, wherein the light shielding plate is laminated on the object side end surface of the lens barrel;
or, a mounting groove is provided on the object side end surface of the lens barrel, the light shielding plate is provided in the mounting groove.

3. The lens structure of claim 1, wherein a thickness of the light shielding plate is 0.01 mm to 0.2 mm, the light shielding plate is of a ring-shaped structure, and an inner diameter of the light shielding plate is 1 mm to 3 mm.

4. (canceled)

5. The lens structure of claim 1, wherein an outer diameter of the object side end surface of the lens barrel is 1.2 mm to 5 mm.

6. The lens structure of claim 1, wherein a maximum distance between a higher one of the object side surface of the light shielding plate and the object side end surface of the lens barrel, and the object side surface of the first optical portion is 0.1 mm to 2 mm.

7. The lens structure of claim 1, wherein the light shielding plate abuts against the object side surface of the first mounting portion of the first lens, so as to fix the first lens to the lens barrel.

8. The lens structure of claim 7, wherein the light shielding plate is of a ring-shaped structure;
the light shielding plate is a cured glue layer directly covering the object side end surface of the lens barrel and the object side surface of the first mounting portion; or, the light shielding plate is sleeved on the first lens, an image side surface of the light shielding plate comprises a first annular connecting portion and a second annular connecting portion arranged and connected successively from outside to inside, the first annular connecting portion is fixedly connected to the object side end surface of the lens barrel, and the second annular connecting portion abuts against the object side surface of the first mounting portion of the first lens.

9. The lens structure of claim 8, wherein the object side end surface of the lens barrel is provided with a first positioning member, the light shielding plate is provided with a second positioning member, the second positioning member mates with the first positioning member to limit relative positions of the light shielding plate and the lens barrel.

10. The lens structure of claim 9, wherein the first positioning member is a post, and the second positioning member is a through hole.

11. The lens structure of claim 10, wherein when the light shielding plate is sleeved on the first lens, the post extends through the through hole, one end of the post protrudes from the through hole, a part of the post protruding from the through hole is a hot riveting portion, and the hot riveting portion is hot riveted and fixed on the object side surface of the light shielding plate, such that the second annular connecting portion of the image side surface of the light shielding plate abuts against and is fixed to the object side surface of the first mounting portion of the first lens.

12. The lens structure of claim 1, wherein the lens barrel is provided with a reference step surface therein configured to support the object side surface of the lenses, a direction from the reference step surface to the object side end surface is a reverse direction, a direction from the reference step surface to the image side end surface is a forward direction, a part of the lens barrel between the reference step surface and the image side end surface is a first barrel body, and a part of the lens barrel between the reference step surface and the object side end surface is a second barrel body, lenses located in the first barrel body constitute a first lens unit, and lenses located in the second barrel body constitute a second lens unit;
wherein an inner diameter of the first barrel body gradually increases or remains unchanged in the forward direction, and an inner diameter of the second barrel body gradually increases or remains unchanged in the reverse direction.

13. The lens structure of claim 12, wherein an inner wall of the first barrel body is stepped, the first barrel body is provided with at least one first step surface therein that is located between the reference step surface and the image side end surface, and the first step surface is configured to support the lenses.

14. The lens structure of claim 12, wherein an inner wall of the second barrel body is stepped, the second barrel body is provided with at least one second step surface therein that is located between the reference step surface and the object side end surface, the second step surface closest to the object side end surface is spaced from the light shielding plate and form a gap therebetween.

15. The lens structure of claim 1, wherein a side surface of the first mounting portion of the first lens abuts against the inner wall of the lens barrel.

16. The lens structure of claim 1, wherein an image side surface of the first mounting portion of the first lens is provided with a positioning protrusion, an object side surface adjacent to the first lens is provided with a positioning groove, and the positioning protrusion is latched in the positioning groove.

17. The lens structure of claim 1, wherein an outer edge of the object side surface of the first mounting portion of the first lens is coplanar with the object side end surface of the lens barrel.

18. A method for assembling a lens structure, comprises the following steps:
providing a lens barrel, the lens barrel being a hollow structure having openings at both ends, the lens barrel comprising an object side end surface and an image side end surface;
providing a plurality of lenses in the lens barrel, and the plurality of lenses are successively arranged from the image side end surface to the object side end surface, one of the lenses located at an end and adjacent to the object side end surface is a first lens, and the first lens comprises a first optical portion and a first mounting portion that are connected to each other, the first mounting portion is located on an outer periphery of the first optical portion; and
providing a light shielding plate on the object side end surface, the light shielding plate extending to the object side surface of the first mounting portion, wherein the object side surface of the first optical portion is exposed from the object side surface of the light shielding plate.

19. The method for assembling the lens structure of claim 18, wherein the lens barrel is provided with a reference step surface therein configured to support the object side surface of the lenses, a direction from the reference step surface to the object side end surface is a reverse direction, a direction from the reference step surface to the image side end surface is a forward direction, a part of the lens barrel between the reference step surface and the image side end surface is a first barrel body, and a part of the lens barrel between the reference step surface and the object side end surface is a second barrel body, lenses located in the first barrel body constitute a first lens unit, and lenses located in the second barrel body constitute a second lens unit, wherein, the inner diameter of the first barrel body gradually increases or remains unchanged in the forward direction, and the inner diameter of the second barrel body gradually increases or remains unchanged in the reverse direction.

20. The method for assembling the lens structure of claim 18, wherein the step of assembling the plurality of lenses into the lens barrel comprises the following steps:
assembling the lenses of the first lens unit into the first barrel body in the reverse direction;
turning the lens barrel by 180 degrees; and
assembling the lenses of the second lens unit into the second barrel body in the forward direction.

21. A camera module comprising the lens structure according to claim 1.
